(19) United States
(12) Patent Application Publication
(10) Pub. No.: US 2026/0194770 A1
(43) Pub. Date: Jul. 9, 2026

(54) PREPARING METHOD FOR FERROFLUID AND DISPLAY DEVICE

(71) Applicant: Chunjie Zhang, Guangzhou (CN)

(72) Inventor: Chunjie Zhang, Guangzhou (CN)

(21) Appl. No.: 19/008,792

(22) Filed: Jan. 3, 2025

(51) Int. Cl. G02F 1/00; C09K 11/02

(52) U.S. Cl. CPC G02F 1/0036; C09K 11/025

(57) ABSTRACT

A preparing method for ferrofluid and a display device are provided, the preparing method for ferrofluid includes the following steps: preparing a storage container; placing a flowing medium in the storage container; preparing a magnetic flow structure; placing a ferrofluid in the storage container to allow the magnetic flow structure to flow in the flowing medium and the magnetic flow structure is insoluble in the flowing medium; forming a delayed emulsification structure by an anti-emulsification substance with an amphiphilic active material; placing the delayed emulsion structure in the storage container so that a delayed emulsification solid is provided on a surface of the magnetic flow structure. The technical solution of the present disclosure can delay an emulsification phenomenon between two media and improve a movement flexibility of the ferrofluid.

### TECHNICAL FIELD

The present disclosure relates to the field of ferrofluid technologies, and in particular, to a preparing method for ferrofluid and a display device.

### BACKGROUND

Ferrofluid, also known as magnetic liquid, ferrofluid or magnetic fluid, is a new type of functional material that possesses both the fluidity of liquid and the magnetism of solid magnetic materials. It is a stable gel like liquid composed of magnetic solid particles with a diameter in the nanometer range (below 10 nanometers), a carrier liquid (also known as a medium), and an interfacial active agent. The fluid has no magnetic attraction in a static state and only exhibits magnetism when subjected to an external magnetic field. At present, ferrofluid can be applied in more and more scenarios, such as speakers, clocks, and pacemakers, and the quality requirements for ferrofluid are also increasing.

However, in a process of using most of the ferrofluid display devices, since the liquid has a certain air solubility and long-term contact with the ferrofluid and transparent liquid, and when shaking or shaking the ferrofluid with a magnet, many bubbles or foam with the ferrofluid will appear at an interface of two incompatible liquids. If the shaking time continues to extend, emulsification and foam with the ferrofluid will appear at the same time, which will shorten the service life of the ferrofluid and reduce the operational flexibility and the rapid recovery. If an emulsifier is added to it, it will cause the magnetic flow liquid and transparent liquid to become turbid, thereby seriously affecting the viewing and movement flexibility of the magnetic flow liquid.

### SUMMARY

The present disclosure proposes a preparing method for ferrofluid, aiming to delay an emulsification phenomenon between two media and improve a movement flexibility of the ferrofluid.

The above-mentioned problems to be solved by the present disclosure is achieved through the following technical solutions.

The method for preparing ferrofluid, including the following steps:
preparing a storage container;
placing a flowing medium in the storage container;
preparing a magnetic flow structure and placing a ferrofluid in the storage container to allow the magnetic flow structure to flow in the flowing medium and the magnetic flow structure is insoluble in the flowing medium;
forming a delayed emulsification structure by an anti-emulsification substance with an amphiphilic active material, placing the delayed emulsion structure in the storage container so that a delayed emulsion solid is provided on a surface of the magnetic flow structure.

In some embodiments of the present disclosure, the magnetic flow structure includes the ferrofluid; the ferrofluid is selected from an aqueous ferrofluid or an oil-based ferrofluid; the flowing medium is an oily liquid or an aqueous liquid.

In some embodiments of the present disclosure, when the ferrofluid is the aqueous ferrofluid, and the preparing a magnetic flow structure includes:
introducing N₂ into a mixed solution of Fe³⁺ and Fe²⁺ with a molar ratio of 4:3 to remove oxygen from a first mixed liquor; adding NaOH solution to the first mixed liquor to adjust a pH of the first mixed liquor to 7.5; heating the first mixed liquor to 80-85° C. and stirring at a constant temperature for 30-38 minutes; filtering and screening a solid and then washing to obtain nano Fe₃O₄;
adding the nano Fe₃O₄ into polyethylene glycol, stirring with a stirrer for 19-19.5 hours, washing repeatedly with deionized water and anhydrous ethanol until a cleaning solution is neutral, then diluting with deionized water until the nano-Fe₃O₄ has a concentration of 0.095-0.099 g/ml, and performing an ultrasound treatment for 37-39 minutes to form the aqueous ferrofluid; or
when the ferrofluid is the oil-based ferrofluid, and the preparing a magnetic flow structure includes:
dispersing magnetite particles in an oil-based dispersion medium in the presence of a surfactant to produce the oil-based ferrofluid; where the surfactant is selected from one of oleic acid, stearic acid, or lauric acid.

In some embodiments of the present disclosure, the magnetic flow structure further includes a chameleon bead luminescent material and the ferrofluid, and the preparing a magnetic flow structure includes:
placing the ferrofluid into a first dissolution medium of a first dissolution container to form a second mixed liquid;
preparing the chameleon bead luminescent material;
placing the chameleon bead luminescent material into the second mixed liquid and stirring evenly at a temperature of 40-80° C. so that the chameleon bead luminescent material is provided on different surfaces of the ferrofluid.

In some embodiments of the present disclosure, the preparing the chameleon bead luminescent material includes:
mixing and stirring a carrier, an oil-soluble carbon black, a diffusion agent, and silicone powders with a mass ratio of 96-97:0.2-0.4:1.3-1.7:0.5-0.7 evenly to obtain a first material;
mixing a color changing pearl powder with the first material in a mass ratio of 1:99 evenly to obtain the chameleon bead luminescent material.

In some embodiments of the present disclosure, the forming a delayed emulsification structure by an anti-emulsification substance with an amphiphilic active material includes:
placing the anti-emulsification substance and the amphiphilic active material into a third dissolution medium, and stirring evenly at a temperature of 40-80° C., so that the amphiphilic active material is provided on a surface of the anti-emulsification substance.

In some embodiments of the present disclosure, the anti-emulsification substance is an inorganic powder material, and preparing an anti-emulsification substance includes:
placing inorganic powders into a second dissolution medium to form a third mixed liquor, and adding a regulating substance to the third mixed liquor to form a fourth mixed liquor; heating the fourth mixed liquor to a first predetermined temperature and maintaining it for a first predetermined time;
cooling down to room temperature and centrifuging to obtain the inorganic powder material.

In some embodiments of the present disclosure, the amphiphilic active material is a carboxylate amphiphilic active material.

The present disclosure further provides a ferrofluid display device using the preparing method for ferrofluid, and the ferrofluid display device includes the storage container, the flowing medium, the magnetic flow structure, and the delayed emulsification structure; where the storage container is provided with a placement cavity, and the flowing medium is placed in the placement cavity; the magnetic flow structure is provided in the flowing medium and is insoluble in the flowing medium; the delayed emulsification structure includes the anti-emulsification substance and the amphiphilic active material, where the amphiphilic active material is provided on the surface of the anti-emulsification substance and is configured to absorbedly connected with the flowing medium and the magnetic flow structure.

In some embodiments of the present disclosure, the magnetic flow structure includes the ferrofluid and a chameleon bead luminescent material, and the chameleon bead luminescent material is provided on a surface of the ferrofluid.

Beneficial effects: the technical solution of the present disclosure is first preparing a storage container, thereby enabling the display device to move in a relatively independent space; then placing the flowing medium inside the storage container; next preparing a magnetic flow structure and placing the ferrofluid inside the storage container to allow the magnetic flow structure to flow in the flowing medium and the magnetic flow structure is insoluble in the flowing medium, so that the magnetic flow structure can move in the flowing medium and improve a movement flexibility. Finally, the delayed emulsification structure is prepared by the anti-emulsification substance and the amphiphilic active material, and then the delayed emulsification structure is placed in the storage container to realize that a delayed emulsification solid to be provided on a surface of the magnetic flow structure, so that the delayed emulsification solid can puncture bubbles or foam generated by the magnetic flow structure during a movement of the magnetic flow structure, so as to achieve a defoaming effect, and the magnetic flow structure and the flowing medium can be at least partially isolated by the delayed emulsification solid. Furthmore, it can delay an emulsification phenomenon between two media, improve the movement flexibility of the ferrofluid, improve the service life of the magnetic flow structure, and solve aesthetic defects caused by the foam at the interface between materials.

### BRIEF DESCRIPTION OF DRAWINGS

In order to provide a clearer explanation of the embodiments of the present disclosure or the technical solutions in the prior art, a brief introduction will be given to the accompanying drawings required for a description of embodiments or the prior art. It is obvious that the accompanying drawings described below are only some embodiments of the present disclosure. For those skilled in the art, other drawings can be obtained based on the structures shown in these drawings without creative work.

FIG. 1 is a flowchart of an embodiment of a preparing method for ferrofluid according to the present disclosure.

FIG. 2 is a schematic structural diagram of an embodiment of a ferrofluid display device according to the present disclosure.

FIG. 3 is a schematic diagram of a delayed emulsification structure of an embodiment of the ferrofluid display device according to the present disclosure.

Numeral reference: 1 storage container; 2 flowing medium; 3 ferrofluid; 4 delayed emulsification structure; 41 first amphiphilic active agent; 42 anti-emulsifying substance; 43 second amphiphilic active agent.

The above is a corresponding explanation of the attached drawings.

### DESCRIPTION OF EMBODIMENTS

Below, the technical solutions in the embodiments of the present disclosure will be clearly and completely described in combination with the accompanying drawings. Obviously, the described embodiments are only a part of the embodiments of the present disclosure, not all of them. Based on the embodiments of the present disclosure, all other embodiments obtained by those skilled in the art without creative work are within the protection scope of the present disclosure.

It should be noted that if directional indications (such as up, down, left, right, front, back, etc.) are involved in the embodiments of the present disclosure, the directional indications are only used to explain a relative position relationship, motion, etc. between components in a specific posture. If the specific posture is changed, the directional indications will also be changed accordingly.

Besides that, if there is a description related to “first”, “second”, etc. in the embodiments of the present disclosure, the description of “first”, “second”, etc. is only for a descriptive purpose and cannot be understood as indicating or implying a relative importance or implying the number of technical features indicated. Therefore, features that are limited to “first” and “second” can explicitly or implicitly include at least one of these features. In addition, if “and/or” or “and/or” appears throughout the specification, its meaning includes three parallel schemes. Taking “A and/or B” as an example, it includes schemes A, B, or both A and B. Furthermore, the technical solutions between various embodiments can be combined with each other, but they must be based on the ability of ordinary technical personnel in this field to implement them. When a combination of technical solutions is contradictory or impossible to implement, it should be considered that this combination of technical solutions does not exist and is not within the protection scope required by the present disclosure.

The present disclosure proposes a preparing method for ferrofluid.

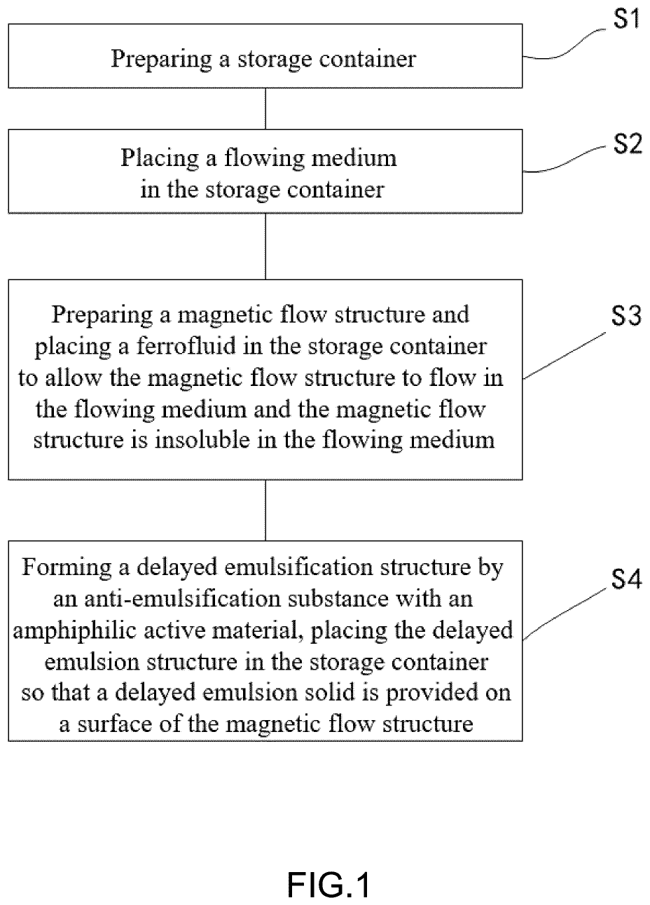

As shown in FIG. 1, in an embodiment of the present disclosure, a preparing method for ferrofluid is described and includes the following steps:
S1: preparing a storage container
S2: placing a flowing medium in the storage container;
S3: preparing a magnetic flow structure and placing a ferrofluid in the storage container to allow the magnetic flow structure to flow in the flowing medium and the magnetic flow structure is insoluble in the flowing medium;
S4: forming a delayed emulsification structure by an anti-emulsification substance with an amphiphilic active material, placing the delayed emulsion structure in the storage container so that a delayed emulsion solid is provided on a surface of the magnetic flow structure.

The technical solution of the present disclosure is first preparing a storage container, so that the display device can move in a relatively independent space; then placing the flowing medium inside the storage container; next preparing a magnetic flow structure and placing the ferrofluid in the storage container to allow the magnetic flow structure to flow in the flowing medium and the magnetic flow structure is insoluble in the flowing medium, so that the magnetic flow structure can move in the flowing medium and improve a movement flexibility. Finally, the delayed emulsification structure is prepared by the anti-emulsification substance and the amphiphilic active material, and then the delayed emulsification structure is placed in the storage container to realize that a delayed emulsification solid is to be provided on a surface of the magnetic flow structure, so that the delayed emulsification solid can puncture bubbles or foam generated by the magnetic flow structure during a movement of the magnetic flow structure, so as to achieve a defoaming effect, and the magnetic flow structure and the flowing medium can be at least partially isolated by the delayed emulsification solid. Furthmore, it can delay an emulsification phenomenon between two media, thereby improving the movement flexibility of the ferrofluid, improving the service life of the magnetic flow structure, and solving aesthetic defects caused by the foam at the interface between materials.

In an implementation mode, the preparing a storage container in S1 includes the following steps:
obtaining a lid and a container body of the storage container separately with a thermoplastic machine and allowing them to stand for a first preset time to prepare the storage container;
pre-cleaning the storage container; where the pre-cleaning includes dust removal and sterilization treatment, drying treatment, etc. Thus, a relatively clean storage container can be obtained, thereby avoiding damage to the flowing medium, magnetic flow structure, and delayed emulsification structure caused by other substances and improving the use safety.

In an implementation mode, the magnetic flow structure includes the ferrofluid; the ferrofluid is selected from an aqueous ferrofluid or an oil-based ferrofluid; the flowing medium is an oily liquid or an aqueous liquid, and the oily liquid is selected from one of hydrocarbon oil, fluorinated oil, fluorinated hydrocarbon oil, chlorinated hydrocarbon oil, glyceride or methyl methacrylate oil; and the aqueous liquid is water.

In an implementation mode, when the magnetic flow structure includes the aqueous ferrofluid, the flowing medium is the oily liquid. In an implementation mode, when the magnetic flow structure includes the oily ferrofluid, and the aqueous liquid is the flowing medium. This structure can avoid a mutual dissolution of the magnetic flow structure and the flowing medium, which affects a smoothness of movement, thus ensuring the movement flexibility of and improving a viewing performance.

In an implementation mode, when the ferrofluid is the aqueous ferrofluid, in S3, the preparing a magnetic flow structure includes:
introducing N₂ into a mixed solution of Fe³⁺ and Fe²⁺ with a molar ratio of 4:3 to remove oxygen from a first mixed liquor, adding NaOH solution to the first mixed liquor to adjust a pH of the first mixed liquor to 7.5; heating the first mixed liquor to 80-85° C. and stirring at a constant temperature for 30-38 minutes; filtering and screening a solid, and then washing to obtain nano Fe₃O₄;
adding the nano Fe₃O₄ into polyethylene glycol, stirring with a stirrer for 19-19.5 hours, washing repeatedly with deionized water and anhydrous ethanol until a cleaning solution is neutral, then diluting with deionized water until the nano Fe₃O₄ has a concentration of 0.095-0.099 g/ml, and performing an ultrasound treatment for 37-39 minutes to form the aqueous ferrofluid and obtaining a colorless aqueous ferrofluid.

In an implementation mode, when the ferrofluid is the oil-based ferrofluid, in S3, the preparing a magnetic flow structure includes:
dispersing magnetite particles in an oil-based dispersion medium in the presence of a surfactant to produce the oil-based ferrofluid; where the surfactant is selected from one of oleic acid, stearic acid, or lauric acid. Using surfactant or epoxy resin to hydrophilic treat the magnetite particles to render them have a hydrophilic layer, and then subjecting the magnetite particles to corona treatment to render them non-magnetic and have a hydrophilic layer on a metal component. Thus, a colorless oily ferrofluid is obtained.

In an implementation mode, the magnetic flow structure further includes a chameleon bead luminescent material and the ferrofluid; and the preparing a magnetic flow structure includes:
placing the ferrofluid into a first dissolution medium of a first dissolution container to form a second mixed liquid, where the first dissolution medium can be selected as a water-soluble medium;
preparing the chameleon bead luminescent material;
placing the chameleon bead luminescent material into the second mixture and stirring evenly at a temperature of 40-80° C., so that the chameleon bead luminescent material is provided on different surfaces of the ferrofluid. By stirring under an appropriate temperature, placing the chameleon bead luminescent material at an interface between the ferrofluid, the ferrofluid is allowed to display different colors, and a movement of the ferrofluid can be more clearly observed, thereby improving a flexibility of use.

In an implementation mode, the preparing the chameleon bead luminescent material includes:
mixing and stirring a carrier, an oil-soluble carbon black, a diffusion agent, and silicone powders with a mass ratio of (96-97):(0.2-0.4):(1.3-1.7):(0.5-0.7) evenly to obtain a first material, where a water carrier can be selected as the carrier;
mixing color changing pearl powders with the first material in a mass ratio of 1:99 evenly to obtain the chameleon bead luminescent material.

In an implementation mode, when an inorganic powder material is used as the anti-emulsification substance, in S4, the preparing the anti-emulsification substance includes:
placing inorganic powders into a second dissolution medium to form a third mixed liquor, and adding a regulating substance to the third mixed liquor to form a fourth mixed liquor; heating the fourth mixed liquor to a first predetermined temperature and maintaining it for a first predetermined time;
cooling down to room temperature and centrifuging to obtain the inorganic powder material.

In an implementation mode, when titanium dioxide powder was used as the inorganic powder material, 100g of titanium dioxide powder was added to 500 ml of water, 15 g of lecithin was added. The mixture was then placed in a 1000 ml three necked flask, heated to 90° C., maintained at that temperature for 120 minutes, cooled to room temperature (20-45° C.) , and centrifuged for separation.

In an implementation mode, when zinc oxide powder was used as the inorganic powder material, 100 g of zinc oxide powder was added to 500 ml of water, 17.5 g of cocamidopropyl betaine was added. The mixture was then added to a 1000 ml three necked flask, and the flask was placed in ultrasonic waves for 30 minutes (prolonged exposure to the ultrasonic, the temperature of the liquid will increase). The flask was then cooled to room temperature (20-45 degrees) and centrifuged for separation.

In an implementation mode, when zinc oxide powder was used as the inorganic powder material, 100 g of zinc oxide powder, 500 ml of water, and 10 g of sodium olivine carboxylate were placed in a 1000 ml three necked flask, then was subjected to ultrasound for 45 minutes, cooled to room temperature and centrifuged for separation.

In an implementation mode, in S4, the forming a delayed emulsification structure by an anti-emulsification substance with an amphiphilic active material includes:
placing the anti-emulsification substance and the amphiphilic active material into a third dissolution medium, and stirring evenly at a temperature of 40-80° C., so that the amphiphilic active material is provided on a surface of the anti-emulsification substance. Thus, it is possible to render the delayed emulsification structure has amphiphilic properties.

In an implementation mode, the amphiphilic active material is a carboxylate amphiphilic active material.

The present disclosure further proposes a ferrofluid display device, which uses the preparing method for ferrofluid. The specific content of the preparing method for ferrofluid refers to the above embodiments. Since this ferrofluid display device adopts all the technical solutions of the above embodiments, it at least has all the beneficial effects brought by the technical solutions of the above embodiments, which will not be repeated here.

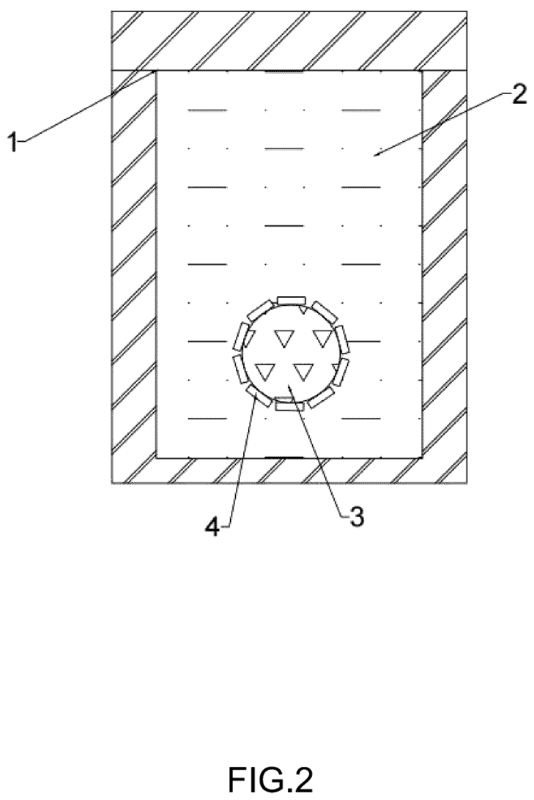

As shown in FIG. 2, the ferrofluid display device includes a storage container 1, a flowing medium 2, a ferrofluid 3, and a delayed emulsification structure 4; the storage container 1 is provided with a placement cavity, and the flowing medium 2 is placed in the placement cavity; the ferrofluid 3 is located in the flowing medium 2 and is insoluble in the flowing medium 2; the delayed emulsification structure 4 includes an anti-emulsification substance 42 and an amphiphilic active material, where the amphiphilic active material is provided on a surface of the anti-emulsification substance 42 and is configured to absorbedly connected with the flowing medium 2 and the ferrofluid 3.

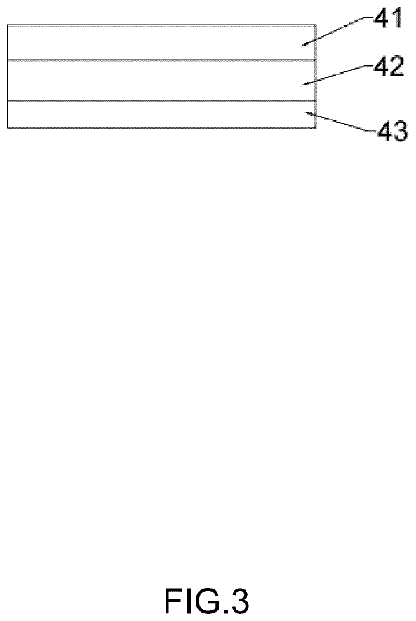

In an implementation mode, as shown in FIG. 3, the amphiphilic active material includes a first amphiphilic active agent 41 and a second amphiphilic active agent 43. The first amphiphilic active agent 41 and the second amphiphilic active agent 43 are respectively provided on two sides of the anti-emulsification substance 42.

In an implementation mode, the magnetic flow structure includes the ferrofluid. The ferrofluid is selected from an aqueous ferrofluid or an oil-based ferrofluid. The flowing medium is an oily liquid or an aqueous liquid, and the oily liquid is selected from one of hydrocarbon oil, fluorinated oil, fluorinated hydrocarbon oil, chlorinated hydrocarbon oil, glyceride or methyl methacrylate oil; and the aqueous liquid is water.

In an implementation mode, when the magnetic flow structure includes the aqueous ferrofluid, and the oily liquid is selected as the flowing medium. In an implementation mode, when the magnetic flow structure includes the oily ferrofluid, the aqueous liquid is selected as the flowing medium.

In an implementation mode, the magnetic flow structure further includes a chameleon bead luminescent material and the ferrofluid, where the chameleon bead luminescent material is provided on the surface of the ferrofluid.

The above description is only preferred embodiments of the present disclosure and does not limit the scope of the present disclosure. Any equivalent structural transformation made under the inventive concept of the present disclosure using the contents of this specification and drawings, or directly/indirectly applied in other related technical fields, are included in the protection scope of the present disclosure.

What is claimed is:

1. A preparing method for ferrofluid, comprising the following steps:
preparing a storage container;
placing a flowing medium in the storage container;
preparing a magnetic flow structure and placing a ferrofluid in the storage container to allow the magnetic flow structure to flow in the flowing medium and the magnetic flow structure is insoluble in the flowing medium;
forming a delayed emulsification structure by an anti-emulsification substance with an amphiphilic active material, placing the delayed emulsion structure in the storage container so that a delayed emulsion solid is provided on a surface of the magnetic flow structure.

2. The preparing method for ferrofluid according to claim 1, wherein the magnetic flow structure comprises the ferrofluid;
the ferrofluid is selected from an aqueous ferrofluid or an oil-based ferrofluid;
the flowing medium is an oily liquid or an aqueous liquid.

3. The preparing method for ferrofluid according to claim 2, wherein when the ferrofluid is the aqueous ferrofluid, and the preparing a magnetic flow structure comprises:
introducing N₂ into a mixed solution of Fe³⁺ and Fe²⁺ with a molar ratio of 4:3 to remove oxygen from a first mixed liquor,
adding NaOH solution to the first mixed liquor to adjust a pH of the first mixed liquor to 7.5;
heating the first mixed liquor to 80-85° C. and stirring at a constant temperature for 30-38 minutes;
filtering and screening a solid and then washing to obtain nano Fe₃O₄;
adding the nano Fe₃O₄ into polyethylene glycol, stirring with a stirrer for 19-19.5 hours, washing repeatedly with deionized water and anhydrous ethanol until a cleaning solution is neutral, then diluting with deionized water until the nano Fe₃O₄ has a concentration of 0.095-0.099 g/ml, and performing an ultrasound treatment for 37-39 minutes to form the aqueous ferrofluid; or
when the ferrofluid is the oil-based ferrofluid, and the preparing a magnetic flow structure comprises:
dispersing magnetite particles in an oil-based dispersion medium in the presence of a surfactant to produce the oil-based ferrofluid; wherein the surfactant is selected from one of oleic acid, stearic acid, or lauric acid.

4. The preparing method for ferrofluid according to claim 2, wherein the magnetic flow structure further comprises a chameleon bead luminescent material and the ferrofluid, and the preparing a magnetic flow structure comprises:
placing the ferrofluid into a first dissolution medium of a first dissolution container to form a second mixed liquid;
preparing the chameleon bead luminescent material;
placing the chameleon bead luminescent material into the second mixed liquid and stirring evenly at a temperature of 40-80° C. so that the chameleon bead luminescent material is provided on different surfaces of the ferrofluid.

5. The preparing method for ferrofluid according to claim 4, wherein the preparing the chameleon bead luminescent material comprises:
mixing and stirring a carrier, an oil-soluble carbon black, a diffusion agent, and silicone powders with a mass ratio of 96-97:0.2-0.4:1.3-1.7:0.5-0.7 evenly to obtain a first material;
mixing color changing pearl powders with the first material in a mass ratio of 1:99 evenly to obtain the chameleon bead luminescent material.

6. The preparing method for ferrofluid according to claim 1, wherein the forming a delayed emulsification structure by an anti-emulsification substance with an amphiphilic active material comprises:
placing the anti-emulsification substance and the amphiphilic active material into a third dissolution medium, and stirring evenly at a temperature of 40-80° C., so that the amphiphilic active material is provided on a surface of the anti-emulsification substance.

7. The preparing method for ferrofluid according to claim 1, wherein the anti-emulsification substance is an inorganic powder material, and preparing an anti-emulsification substance comprises:
placing inorganic powders into a second dissolution medium to form a third mixed liquor, and adding a regulating substance to the third mixed liquor to form a fourth mixed liquor;
heating the fourth mixed liquor to a first predetermined temperature and maintaining it for a first predetermined time;
cooling down to room temperature and centrifuging to obtain the inorganic powder material.

8. The preparing method for ferrofluid according to claim 1, wherein the amphiphilic active material is a carboxylate amphiphilic active material.

9. A ferrofluid display device using the preparing method for ferrofluid according to claim 1; and the ferrofluid display device comprises the storage container, the flowing medium, the magnetic flow structure, and the delayed emulsification structure;
wherein the storage container is provided with a placement cavity, and the flowing medium is placed in the placement cavity;
the magnetic flow structure is provided in the flowing medium and is insoluble in the flowing medium;
the delayed emulsification structure comprises the anti-emulsification substance and the amphiphilic active material,
wherein the amphiphilic active material is provided on the surface of the anti-emulsification substance and is configured to absorbedly connected with the flowing medium and the magnetic flow structure.

10. The ferrofluid display device according to claim 9, wherein the magnetic flow structure comprises the ferrofluid and a chameleon bead luminescent material, and the chameleon bead luminescent material is provided on a surface of the ferrofluid.
